(19) United States
(12) Patent Application Publication
(10) Pub. No.: US 2008/0211807 A1
(43) Pub. Date: Sep. 4, 2008

(54) Mesh Design Method and Tool

(75) Inventor: Sebastien Deguy, Clermont-Ferrand (FR)

Correspondence Address: OSLER, HOSKIN & HARCOURT LLP (OTHER), 1000 DE LA GAUCHETIERE STREET WEST, SUITE 2100, MONTREAL, QC, H3B-4W5, CA

(73) Assignee: ALLEGORITHMIC, Aubière (FR)

(21) Appl. No.: 11/573,073

(22) PCT Filed: Aug. 3, 2005
(86) PCT No.: PCT/EP2005/008402

§ 371 Date: Dec. 20, 2007

(30) Foreign Application Priority Data
Aug. 10, 2004 (FR) 04/08810

(51) Int. Cl. G06F 13/14

(52) U.S. Cl. 345/420

(57) ABSTRACT

A mesh designing process to generate or modify a mesh (60) of an input assembly comprising a plurality of elementary geometrical forms (61), consisting to:
a. input the mesh data (60) to process in a mesh modification tool;
b. input the parameters of at least one modifiable procedural map (50) intended to provide a spatial cursor in a tool for generation or modification of procedural maps;
c. generate the procedural map (50) using said tool for generation or modification of modifiable procedural map;
d. carry out a mapping between the various points of the procedural maps (50) and the corresponding mesh (60) points or parameters;
e. rearrange at least part of the points of an input assembly according to the data provided by the procedural maps in order to generate a spatial arrangement modified for at least part of the elementary geometrical forms.

The invention also relates to a corresponding mesh designing tool.

The present invention relates to a tool and a mesh design method likely to be used in the majority of the fields where mesh is used, such as for example the modeling of images or objects, video games, video in general, industrial design, etc.

A large number of applications in three dimensions are entirely or partially carried out with mesh. This method of image construction is very practical and comprises many advantages, such as for example the fact of being able to cover the same mesh in several distinct ways, thus making it possible to easily and quickly generate several objects having an identical or similar basic structure.

On the other hand, in the many cases where one must modify an existing mesh, handling to be carried out is in general tiresome and expensive. It is necessary either to start again or rebuild a new mesh, or to manually modify each point which one wishes to reposition, by manually adding the eventual complementary points necessary to the enrichment of the initial mesh. In the cases where many objects are to be processed, the generated costs can easily become prohibitory.

To alleviate these disadvantages, the present invention provides a mesh design process to generate or modify a mesh of an input assembly comprising a plurality of elementary geometrical forms (such as triangles) describing a surface in a three-dimensional space according to an initial spatial arrangement on which the procedural map is likely to act in order to modify the said arrangement, comprising the steps consisting to:
a. introduce the data constituting the mesh to be processed in a mesh modification tool;
b. introduce the parameters of at least one modifiable procedural map intended to produce a spatial cursor in a tool for generation or modification of procedural maps;
c. generate the procedural map with said tool for generation or modification of modifiable procedural map;
d. carry out a mapping between the various points of the procedural maps (or of the spatial cursor) and the corresponding mesh points or parameters;
e. re-arrange at least part of the points of the input assembly according to the data provided by the procedural maps in order to generate a modified spatial arrangement for at least part of the elementary geometrical forms.

According to an advantageous embodiment, the rearrangement of the points is managed by at least one modifiable procedural map comprising indications relative to a direction and a distance for the points to be moved. According to various embodiments, these indications can be contained either in only one map or in several maps (for example a map with direction vectors and a map with the distances or lengths). According to another variant, the direction vectors are normals with respect to the surface defined by the mesh.

Each point of the initial spatial arrangement is likely to be moved according to the direction indicated by the spatial cursor. This direction can be selected among a plurality of spatial directions. In general, it can be any angle (unspecified angle); according to a specific example of realization, said angle is an orthogonal angle. It should be noted that each point can be moved independently (and thus differently) from the others.

Advantageously, said map is a procedural map, having a tree structure, comprising a plurality of levels, each one with at least one node

Advantageously, the process also comprises one subdivision step consisting in subdividing at least one portion of the elementary geometrical forms. The subdivision factor can be fixed and is at least of 2, but is advantageously selected by the user according to the context.

The subdivision step consists for example in:
to check if the subdivision stop criterions is reached;
if the criterion is not satisfied, to carry out at least one subdivision and go back to step (a);
if the criterion is satisfied, stop the subdivision.

According to various embodiments, either one subdivides once and moves the newly introduced points, then one subdivides again, and so on, or, whenever the subdivision criterions does not depend on the points position, one initially carries out all the subdivisions, then moves all the new points for which a displacement is planned.

The subdivision stop criterion can be a threshold, a minimum, etc

The possibility of carrying out one or more subdivisions of at least part of the mesh in order to increase the number of elementary geometrical forms is particularly interesting. It enables to use a simple starting mesh, which can thereafter be supplemented in a suitable way to carry out tasks more complex than those permitted by the simple starting mesh. The subdivision thus enables to generate the additional points which allow adjusting the complexity or density of the mesh according to the level required to reach the desired result. Such an automatic subdivision allows considerable time savings, since manual processing of such additions of points takes a long time and is very tiresome.

A test allows to check if for example the desired mesh requires or not the addition of new points. For example, one can check if the variation compared to the theoretical result (the one which would be obtained if one carried out infinity of subdivisions loops) is acceptable. Otherwise, according to another example, if a test is independent of the point's position, one can then check if the number of elementary geometrical forms is at least equal to that needed by the user.

According to an advantageous embodiment, a threshold is posed, for example according to the number of elementary geometrical forms and or the desired precision, or of the sharpness of the subdivision, etc. As long as the threshold is not reached, new points are added by subdividing the elementary geometrical forms. Depending on the cases, the subdivision can relate to the totality of the elementary geometrical forms, or to only part of those.

Advantageously, the process according to the invention operates with a display of the mesh. The mesh is thus preferably displayed at all steps, either before it is modified, during and after modification. According to an advantageous variant, the display allows to visualize the mesh and the procedural map(s) provided on the mesh, with correspondence of the points. Such visualization can be made easier for example with a coloration of the mesh according to the map.

Advantageously, the process according to the invention is operating with a display of at least one of the implemented procedural maps, or of at least a portion of those. Such a display is very useful to adjust the parameters of a map during work. Moreover, if one or several maps must be modified, such a display is particularly useful.

Advantageously, the process according to the invention comprises one or more steps consisting in modifying the procedural map/spatial cursor. After modifications of the maps, one can then proceed directly to the step of repositioning the mesh points.

One or more procedural maps can be modified before or after mesh points were repositioned. Preferably, the handling of the selection of the portion of the mesh to be modified is carried out from the mesh display window. The user can also have the possibility of visualizing the operations that are carried out due to a map representation on the mesh which reflects the modifications in progress. Displacement calculations are preferably carried out at the end of the modifications, (and activated for example using an instruction: “mesh creation”) in order to optimize the necessary computing time. Thus, the mesh display window—presenting at the same time the mesh and the map applied to this mesh—advantageously allows displaying the representation of the modified procedural map substantially as the modifications are carried out.

The work carried out in the mesh display window enables to obtain a very ergonomic and very visual tool and work method, being very useful for the user. In fact, if the modifications under development are not presented or are only presented in the display window of the procedural map, the user may face certain difficulties in imagining the result of these modifications on the mesh.

According to an advantageous embodiment, the map/spatial cursor is time dependant. This mode of realization enables to create structures which vary according to time. In such a case, the subdivisions must be realized before displacements. Thus, the mesh point's position depends on time, but the number of elementary geometrical forms as well as topology are preferably independent of time.

According to a preferred embodiment, the mesh is generated by a mesh generator, for instance during the introduction of the mesh data/parameters into the mesh modification tool.

According to various alternatives, various tests may be used to prevent the points or summit from being deployed beyond a useful limit from which they are no longer visible. Indeed, it is in general useless to place points at no visible positions. This causes useless calculation capabilities and memory losses. It is thus possible to check for each elementary geometrical form whether it forms or not an intersection with another. To minimize the required time, it is often more useful and sufficient to carry out this type of test only for a limited number of elementary geometrical forms, for example those located in a given vicinity.

Moreover, the invention provides a mesh design tool intended to generate or modify a mesh of an input assembly comprising a plurality of elementary geometrical forms (such as triangles) describing a surface in a three-dimensional space according to an initial spatial arrangement on which the procedural map is likely to work in order to modify said arrangement, said tool including:
a mesh input unit, to receive the data corresponding to a mesh to be modified;
a procedural map generation or modification tool, allowing the generation of procedural maps having a tree structure, comprising a plurality of levels, each one with at least one node to which at least one parameter is associated, intended to generate a spatial cursor, comprising:
a map parameter input unit, to receive preset parameters of procedural maps taking into account the data of at least an input assembly on which the spatial cursor will work in order to modify the initial spatial arrangement;
a processing unit, intended to process said parameters, in order to generate said spatial cursor map, so that the map has a tree structure;
operating instructions, to ensure the tool operation and in particular of the processing unit;
an output, allowing to transmit the processed maps;
an integrator, capable on the one hand to put in correspondence the various points of the spatial cursor with the corresponding mesh points, and on the other hand to re-arrange at least part of the points of the input assembly according to the data provided by the procedural maps in order to generate a spatial arrangement modified for at least part of the elementary geometrical forms.

Because the procedural maps with tree structure are modifiable, the tool according to the invention provides to the user a great working flexibility. Thus, the modifications may be made easily and quickly, with an adapted tool, rather than manually.

The tool according to the invention advantageously comprises, during its implementation, a mesh display window, capable to present the mesh to be modified (preferably before, during and after the integration).

Said tool preferably comprises a node selection tool allowing the selection of at least one node of one level.

Such a tool can be set up via the procedural map display window, or via the mesh display window. It enables for example to move a selected portion and/or to modify the parameters of one (or even several) procedural maps associated with this sole selection. The remainder of the map can either remain unchanged, or be modified according to other parameters.

According to a preferred variant, the mesh design tool further comprises:
a map parameters selection and modification tool, for on the one hand selecting a parameter to be modified, and on the other hand to allow the input of the parameter new value;
a processing unit intended to process said parameters in order to generate said modified spatial cursor map;
operating instructions, to ensure the operation of the tool and in particular of the processing unit;
an output, allowing to transmit the modified map.

The node selection tool advantageously comprises a unit for the selection of depth, enabling the selection of the extent of the modification to be made on the tree. According to another example of realization, it comprises a mobile frame for the localization of the object-node. Said frame can be operated directly from the working interface by a cursor.

According to another advantageous embodiment, the mesh design tool also comprises a mesh generation module. Such a module can be arranged to cooperate with the mesh input unit. The user thus has a tool allowing him to create a mesh which is easily modifiable later on with the other features of the mesh modification tool.

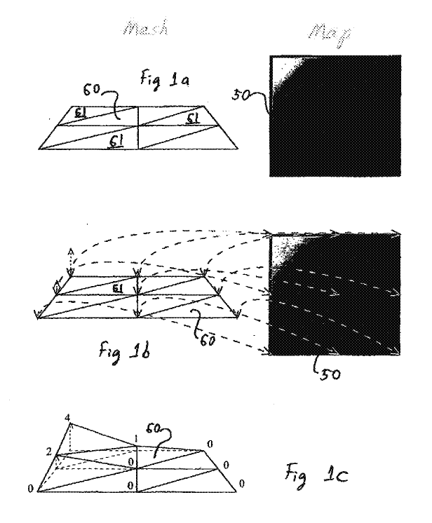

The invention will be described using attached FIGS. 1 to 24, presented exclusively as non-restrictive example, in which:

FIGS. 1a, 1b and 1c illustrate the basic principles for the mapping between the points of the procedural maps and the corresponding points of the mesh to be modified;

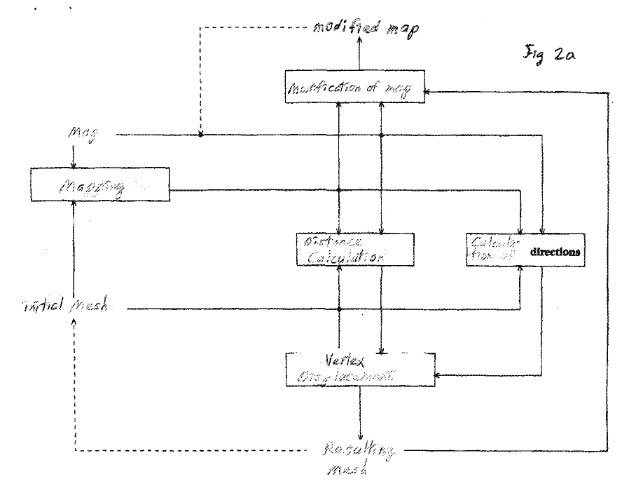

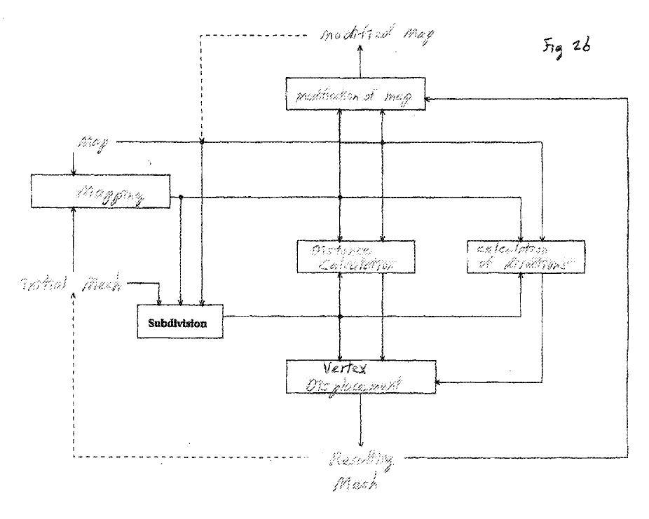

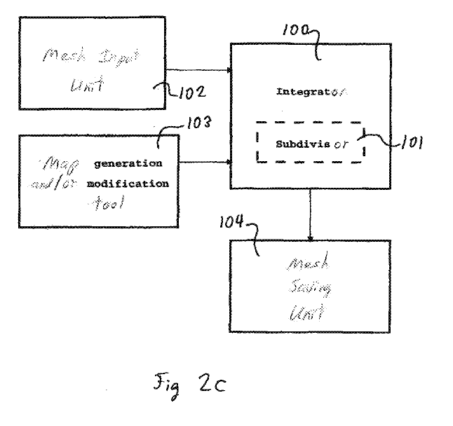

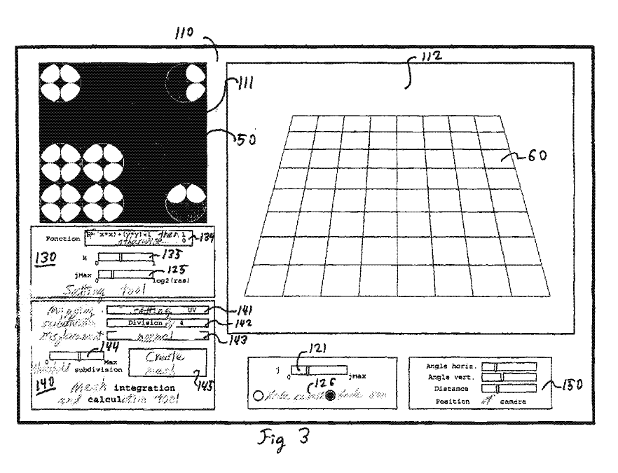

FIGS. 2a and 2b present the main steps for two embodiments of the process according to the invention;

FIG. 2c illustrates the main functional elements of the tool according to the invention during its operation;

FIGS. 3 to 8 show on the one hand the working interface of the tool according to the invention, and on the other hand the various steps enabling the modification of a mesh starting from a modifiable procedural map;

FIGS. 9 to 14 illustrate various tree structure examples for procedural maps, examples of parameters and examples of modifications;

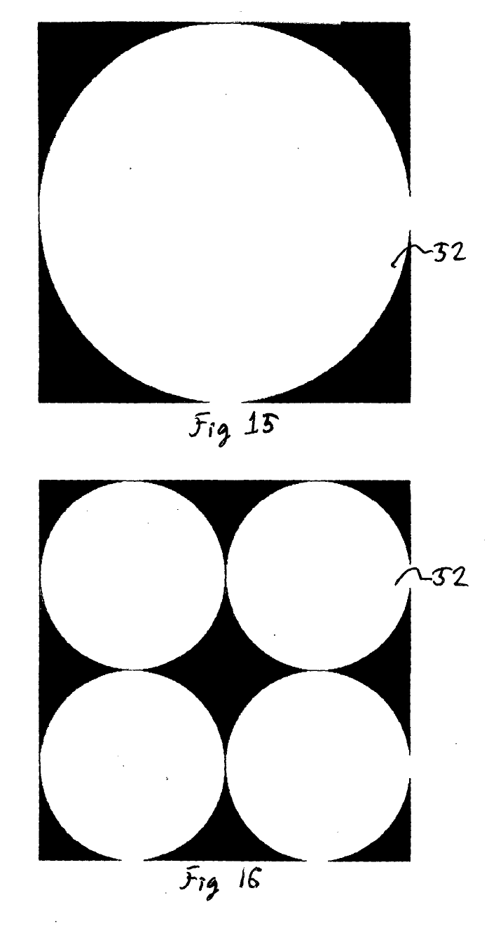

FIGS. 15 to 19 illustrate various examples of procedural maps having a tree structure;

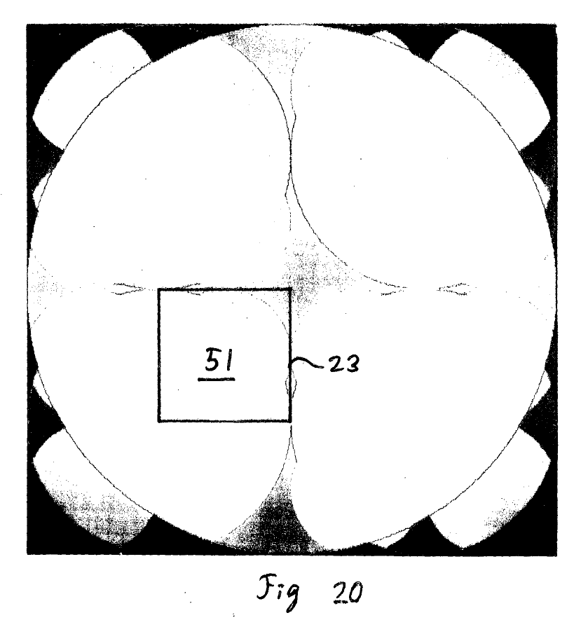

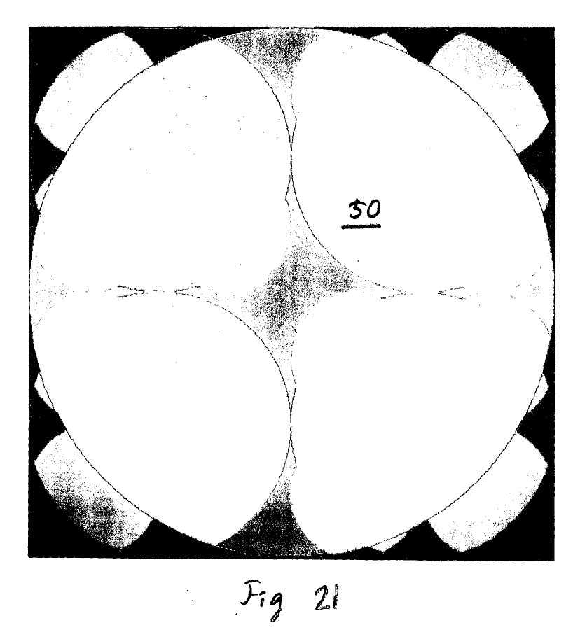

FIGS. 20 to 23 show examples of modifications made to modifiable procedural maps;

FIG. 24 illustrates an example of an interface for a tool enabling to generate and/or modify procedural maps having a tree structure.

The present invention is based on the use of procedural maps having a tree structure. FIGS. 9 to 14 illustrate examples of such trees (for the specific case in which n=1, where N is the dimension of the support. For example, n=2 for an image, n=3 for a volume, n=1 for a curve). In the example of FIG. 9, with j=0, one finds a simple node. Two children or son nodes are on the level j=1, and four on the level j=2. All the nodes are similar. The function F has an important contribution to the definition of the base form of the node-object. It is also indicated in this document by the term “morphlet”. A morphlet can practically take any form. Such a procedural map having a tree structure can be represented by the following equation:

ΣΣF(2j x−k), (j, k)

forming a tree T, and also represented in this document by:

ΣF(2j x−k) i.
(j, k)εT
   in which:

F is a function or morphlet Rn→R

x is a vector of the type (x1, x2, . . . , xn);

T is a tree including nodes (j, k) and in which
j indicates the current level, among a total potential number of levels jmx (Jε(0, 1, 2, . . . , jmax);

k is a displacement vector for each node N and of the type (x1, x2, . . . , xn).

FIGS. 9 to 14 illustrate examples of local modifications which it is possible to provide thanks to the tree structure according to the invention. For example, on FIG. 10, different values for H were set. Thus, the half tree on the left of FIG. 10 comprises a value of H of 0,2; that of right-hand side, a value of H of 0,8.

The tree is symmetrical but the invention enables to produce unsymmetrical trees. This type of modification may allow to locally modify the level of roughness of a map: while tending towards H=1 a surface will be smoother; while tending towards H=0, a surface will be rougher.

On FIG. 12, certain sub-trees or branches are removed. The parameter P represents a probability of removing branches from a tree. With p=0,2, there is a probability of 0,2 to remove branches; for p=0,8, this probability is of 0,8. This parameter can be adjusted to preserve or not a high density of sub-trees.

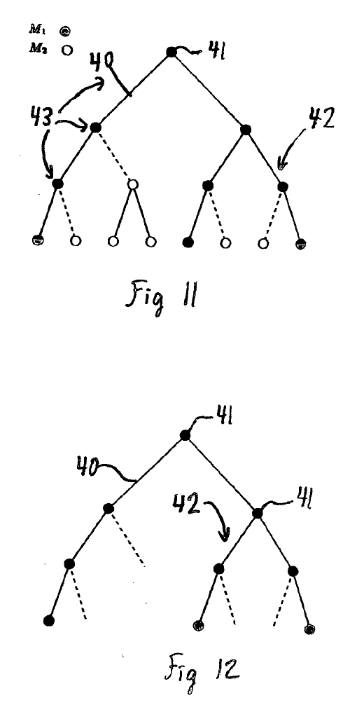

FIG. 13 illustrates the possibilities offered by the parameter D, that is to say the shift. The shift enables to move one or more nodes from their original positions.

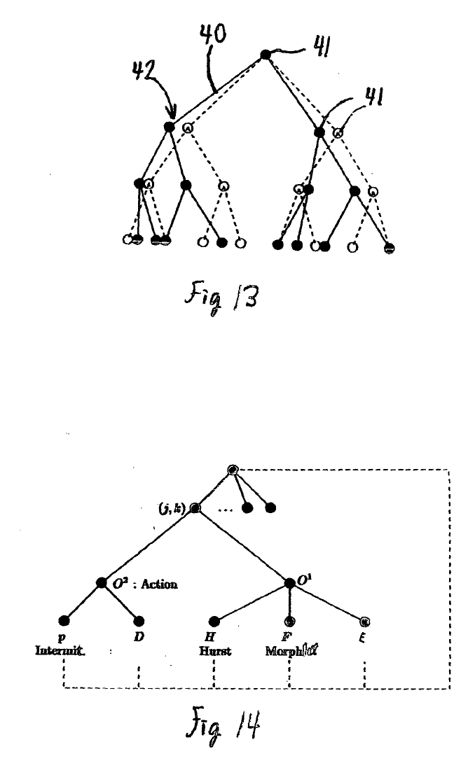

Lastly, FIG. 14 illustrates the large types of parameters with which the invention allows to work to create or modify procedural maps: action parameters such as p and D, and structure parameters, such as H, F and ξ.

FIGS. 15 to 19 illustrate examples of procedural maps having tree structures. For example, FIG. 1 presents an example in which a morphlet of the type F=1, if X2+y2<1, otherwise, F=0. With j=0, with a single node, a single node-object NO is generated, having the shape of a uniform and centered disc (FIG. 15).

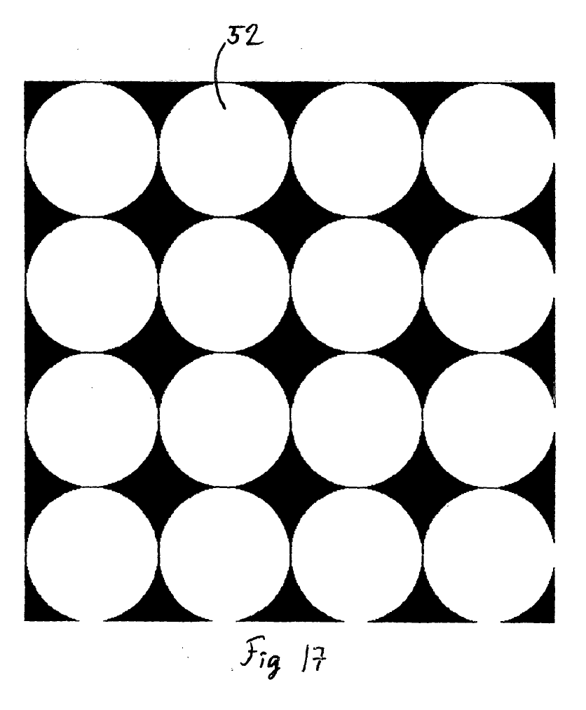

For j=1, on the second level, FIG. 16, one finds four node-objects, in this example, four discs of smaller size, each one being uniform. This layer is thus divided into four sections, each one forming a node-object. Each section occupies ¼ of the initial map, according to the quadratic and uniform arrangement of this example. One thus sees the effect of the main parameters: j indicates the current level, k allows the displacement of node-objects, in this example from the center of the map towards the center of one of the quarters. The morphlet basic F remains unchanged.

The following figure (FIG. 17) illustrates the 3rd level (j=2), for a similar morphlet. From the preceding level, there is a new subdivision in four quarters, each quarter having its node-object, in this example, a similar disc, but becoming smaller and smaller.

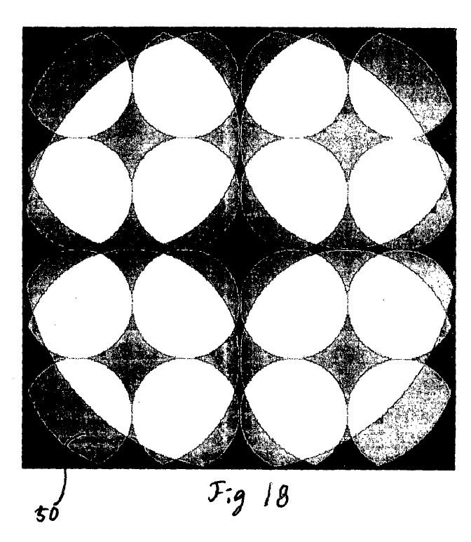

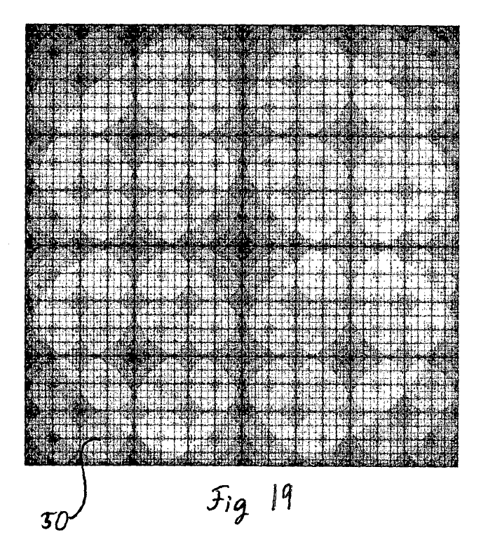

FIG. 18 shows the sum of these various layers. This very simple example allows to clearly visualize the base forms of each level. FIG. 19 illustrates a sum of the same type but for a higher number of levels, therefore a higher number of node-objects, resulting in a more complex structure in this example.

### EXAMPLES OF MODIFICATIONS

FIGS. 20 to 23 illustrate examples of modifications of maps which it is possible to realize using the method and the tools according to the invention. On FIG. 20, the mobile frame 23 of the node selection tool 20 is localized on a node-object 51 to be processed. The following figure illustrates the result following the suppression of this node. One clearly sees that the modifications can thus be made on a local level, without affecting the remainder of the map.

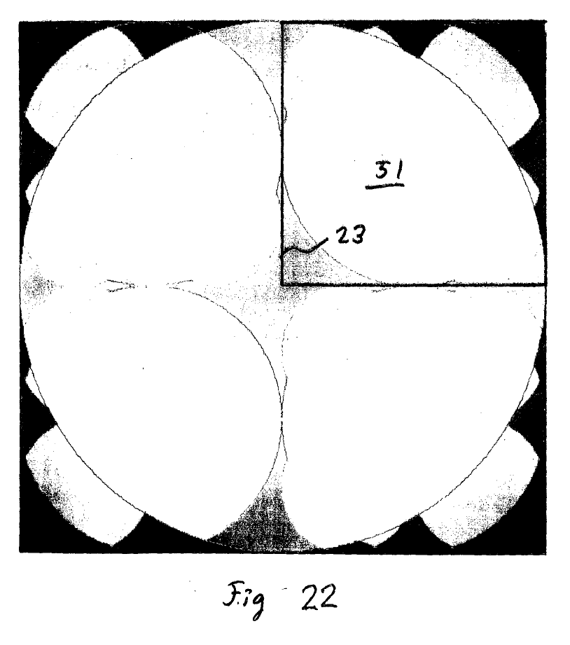

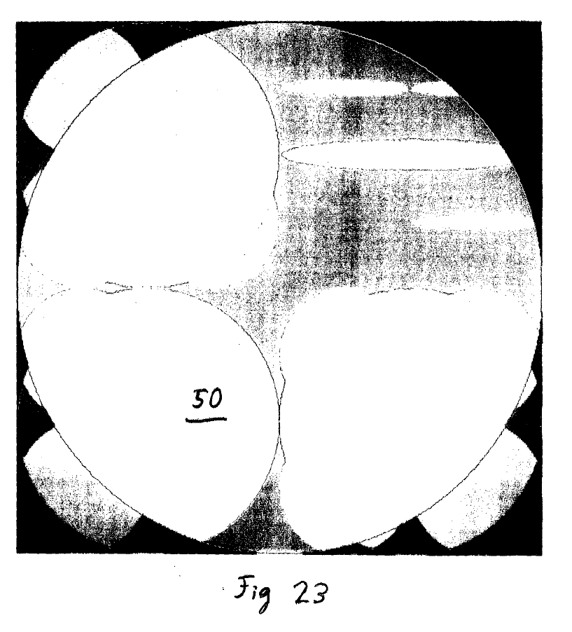

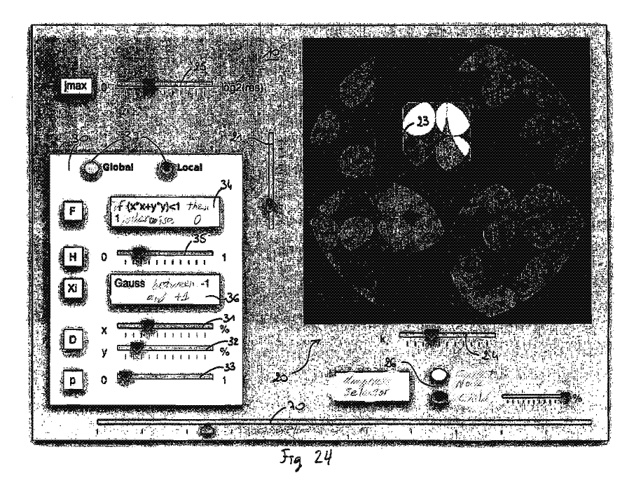

FIGS. 22 and 23 illustrate a similar process of modification of the parameters at the node level. In this example, the function or morphlet F was modified, thus affecting the base form of the node-object of this quarter of the map. Indeed, one sees on FIG. 23 the discs of FIG. 22 which are now thinned or crushed.

FIG. 24 illustrates an example of working interface obtained by a tool 10 of generation and/or modification of procedural maps having a tree structure. According to various variants of realization, such a tool can be provided either for the modification of existing procedural maps, or for the generation and the modification of such maps.

The basic tool comprises a tool 20 for selection of nodes, including a selector 21 of level J, and a selector of node, allowing the selection of a given node in the selected level. In practice, as described hereafter, the user selects a layer, corresponding to a given level J and a node-object, corresponding to a node K.

Tool 10 comprises a tool for parameter setting 30, allowing to select a parameter, either to set a first value for it, or to modify it or adjust it, according to the case. To modify a map, one or more nodes 41 are first of all selected. A tool such as a node selector 20 offers this possibility. Such a tool can advantageously provide two functions: a level selection unit 21, and a node selection unit.

The tool for node selection comprises a mobile screen target 23. This screen target is advantageously configured in order to allow the delimitation of at least one node-object 51 in a given layer. In the illustrated examples, the target is of substantially square form. To facilitate the selection of the nodes, the tool comprises a displacement mode in order to allow the auto positioning of the target on an node-object or a set of node-objects, for example the nodes that are the closest, when the target is not perfectly positioned by the user on a node. The target may be operated by any type of traditional computer command, such as a mouse, a pointer, keyboard keys such as the arrows, or a remote control such as a machine, an especially designed circuit or command software. It can also be controlled directly from the node selection tool interface 20, for example using a cursor 24 controlling the displacement of the target 23 on the map.

Advantageously, the tool 23 is configured so that when a level is selected, the shape and the size of the frame 23 adapt to those of node-object 51 of the corresponding level. The tool 23 allows selecting any node of the selected level.

According to another variant, the node selection tool 20 comprises an indication means, allowing to clearly indicate to the user which nodes are selected. Such an indication can be provided by a change of color or intensity, a flickering, or any other effective visual means.

Tool 10 preferably comprises a depth selector 26, allowing the user to indicate if the operation in progress relates only to the nodes of the selected level or if the sub-trees must also be processed in a similar way.

Then, its value (modified or initial) may be entered. The tool is advantageously adapted in order to be able to process at least one, but preferably all the types of parameters illustrated in this document, such as: F: 34, H: 35, ξ: 36, p: 33, D (x): 31, D (y): 32.

The interface allows the user to set a value to the various parameters. For example, for F, the user enters a function, such as the one illustrated. According to a variant, a pull-down menu may propose to the user a series of functions among which he may choose. It is the same for the parameter ξ. For the parameter p, the user sets a value, for example between 0 and 1, for example using a cursor or another similar tool. A pull-down menu may also be proposed. For the parameters H and D (for x and y), if the user chooses the internal mode, the values can be set in a way similar to that of the parameter p, with values for example between 0 and 1 for H, and expressed as a percentage for D. A time scale 70 representing time allows working with maps whose parameters may vary according to time.

Procedural maps having a tree structures and mesh

FIGS. 1a, 1b and 1c present the basic principle on which the present invention is founded. This example is voluntarily very simple for demonstration purposes. One clearly understands that many applications in the field of the computer graphics imply more complex mesh and procedural maps.

A mesh 60 made up of a certain number of elementary geometrical forms 61, is provided with an initial spatial arrangement. Information or data being used to modify the position of at least one of the elementary geometrical forms 61 is provided by one or more procedural maps 50 having a tree structure 40. In the example of FIG. 1a, eight triangles 61 are arranged in a plan in order to form a square. The procedural map 50 must contain at least repositioning information for the points to be moved. The map 50 thus has different information in its upper left portion, corresponding to the points to be moved, than those of the remainder of the map, corresponding to points which one does not wish to move. FIG. 1b shows the correspondence between the sections or areas or points of the procedural map 50 of instructions or positioning calculation, and the various points of the mesh 60 to modify. A point of the map corresponds to each point of the mesh. The pairing of the corresponding points in this example is carried out simply, as if one superimposed the procedural map on the initial mesh. Correspondence arrows of FIG. 1b illustrate this aspect.

When the mapping is carried out, the data being used to reposition the mesh points 60 are transferred or sent to the calculator. In this theoretical diagram, one illustrates the transposition of the map towards the mesh. In practice, a computation means or tool is necessary to read or interpret the map positioning data and to set the new position.

FIG. 1c illustrates the result of the calculation carried out to reposition the points to be moved. The displacement information contained in the map was applied to mesh 60. One notes that the light portion of map 50 containing non null values allowed the repositioning of a corresponding portion of the points of mesh 60, according to the values contained in the map.

The repositioning data can be provided in any format allowing setting a new position, for example using vectors. For this reason, several complementary procedural maps may be useful to provide the data. For example, a map for the distances, and one for the angles or directions. In the example illustrated on FIG. 1, displacements are orthogonal; a distance map alone is enough to establish the new positions. The FIG. 1c also presents examples of displacement values for the points which were repositioned.

The procedural maps thus act like spatial cursors, allowing redefining the positions of various points of a mesh to be modified.

FIGS. 2a and 2b present functional diagrams allowing illustrating the various steps of the method according to the invention. A starting mesh 60 is considered in order to modify it. A procedural map 50 is set by the user. This map contains the parameters or data relating for displacements of the points to be carried out. A step of mapping allows pairing the points of the map 50 with those of the mesh 60. The transmitted data then allow carrying out distances calculations and possible direction calculations (for the cases where displacements are not orthogonal). The point's displacement step may then be carried out. A modified mesh is thus obtained.

According to an advantageous embodiment, the method and the tool according to the invention allow to proceed to modifications of the procedural map or maps. The map is modified by the user, using tools which are described further in this document. From this modified map, applied to the starting mesh, calculations of distances and directions are carried out, allowing carrying out displacements of the mesh points. A new mesh is then obtained. This new mesh can of course be modified again, as many times as necessary, to obtain a satisfactory result.

Although FIG. 2a presents the steps of calculations and displacements as being carried out in a successive way, those can be carried out in parallel, or according to a different order. Of course, the step of displacement is advantageously carried out at the end of the process, in order to allow obtaining first the complete necessary data to carry out these displacements.

FIG. 2b presents an advantageous variant of FIG. 2a, including in addition one (or several) mesh 60 subdivision steps. It is indeed frequent that the basic mesh is not sufficiently dense to allow obtaining the expected result starting from the displacements data provided. Rather than to proceed manually for the addition of the missing mesh points, the method and the tool according to the invention allow to enrich or increase the mesh density in adding, using an iterative process, the missing points. This extremely advantageous characteristic of the invention is described more in details later on in this document.

FIG. 2c presents the various functional elements used at the time of the implementation of the invention. An integrator 100 receives on the one hand the data from a mesh 60 input unit 102, and on the other hand the data of a procedural map generation and/or modification tool 103. Integrator 100 comprises arithmetic instructions enabling him to carry out the mapping or pairing of the maps with the mesh. It also comprises arithmetic instructions enabling him to calculate the distances and the possible directions, in order to carry out displacements of the mesh points for which informations relating to a displacement were provided.

The resulting mesh is preferably saved by a mesh saving unit 104.

Integrator 100 also plays a key function for cases where a map must be modified. In an advantageous way, it enables to manage or carry out these modifications from the mesh display window. The informations relating to the provided modifications are transmitted to the map generation/modification tool, which generates the new map comprising these modifications. Lastly, the integrator enables to carry out calculations relating to the distances and the possible directions for a modified map. Displacements of the corresponding points may then be made.

FIG. 3 illustrates an example of working interface 110 of such an integrator 100. The illustrated example has two display windows: a first window 111 to visualize the map 50 or at least a portion of a map during use, and a window 112 of visualization of the mesh. According to an advantageous embodiment of the invention, this second window 112 enables to represent not only the mesh 60 alone, but also the assembly resulting from the mapping of the maps with the mesh. This aspect is particularly advantageous and highly facilitates the work of the user who can thus visualize the elements for which he wishes to carry out modifications.

Tools for maps parameter setting 130 are provided in the working interface 110 and comprise, in the illustrated example: a “function” command 134 to enter or modify the basic function of the procedural map used. A command 135 to enter or modify the value of H, and a command 125 to enter or modify the value of Jmax. Other commands enabling to enter or modify other values of parameters can also be used on this interface, such as for example the commands presented in the parameter setting tool 30 of the interface of FIG. 24 (for parameters Xi, D and p). In addition, as in the interface of FIG. 24, interface 110 of integrator 100 may present a time scale in order to enable to set one or more parameters which may vary according to time.

Mesh integration and calculation tools 140 are also presented on FIG. 3. These tools comprise a command for selection of the mapping mode 141 which enables to choose among known modes, such as mapping by parameterization UV, spherical, cylindrical, cubic, planar, etc

A command for subdivision 142 enables to set the importance of the subdivisions to be made. In the illustrated example, it is a division by 4. A displacement command 143 enables to enter the displacement mode (or angle). According to a variant of realization, this command is advantageously replaced by one or more procedural maps, in particular whenever the angles are not all the same ones for all the points. In the illustrated example, it is a displacement according to a normal to the plan. A threshold command 144 enabling to adjust the subdivision threshold is also present. In the example, it is a cursor enabling to select a value between 0 and the maximum threshold. Lastly, the illustrated example comprises a control command 145 to launch the mesh creation, i.e. the step of displacement of the points.

The commands provided under the mesh display window are advantageously dedicated to the options and tasks carried out using this window. For example, in the illustrated example, a command for level selection 121 enables to select on which level or stage on the tree the modification in progress must be applied. In addition, a depth selector 126 enables to indicate if the modification applies only to the current node or to all the nodes which depend on it (the children nodes).

Lastly, the working interface preferably comprises a “camera position” command 150 enabling to simulate a camera positioning with respect to the object under process. In the illustrated example, this command enables to select the angles of visualization as well as the distance between the camera and the object.

In addition to the basic interface, FIG. 3 presents an example of basic mesh 60 used as an input assembly, presented in the mesh visualization window 112. The other window 111 presents an example of procedural map 50 having a tree structure, which will enable to carry out modifications of the basic mesh presented on FIG. 5.

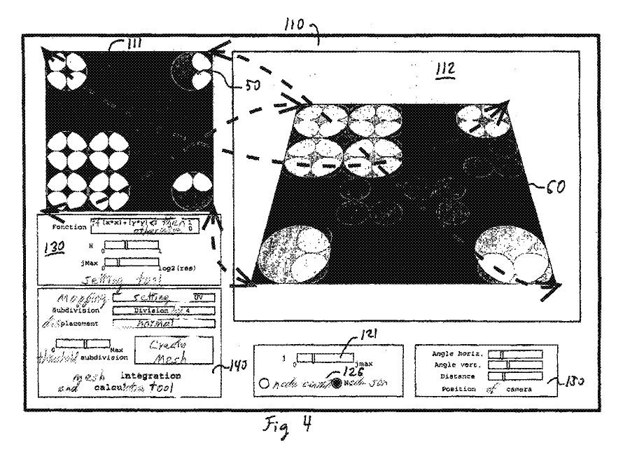

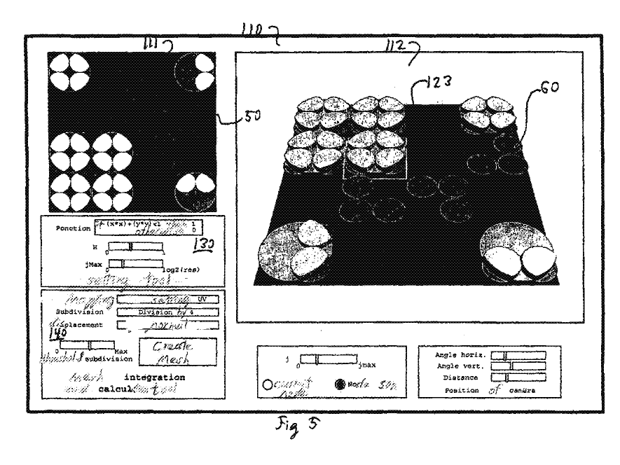

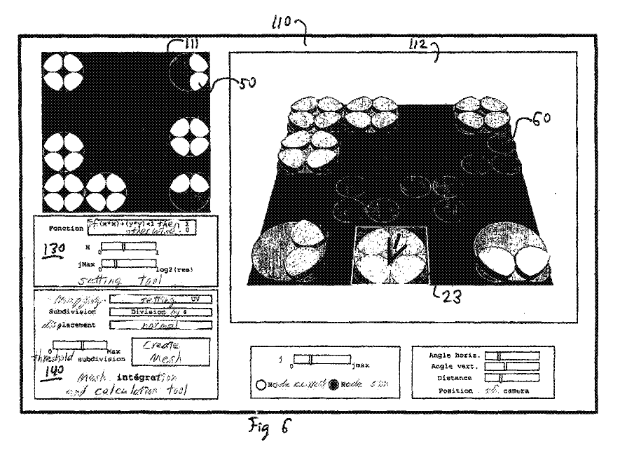

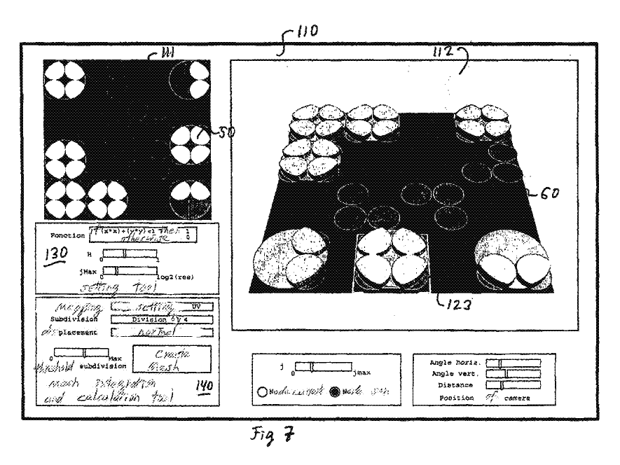

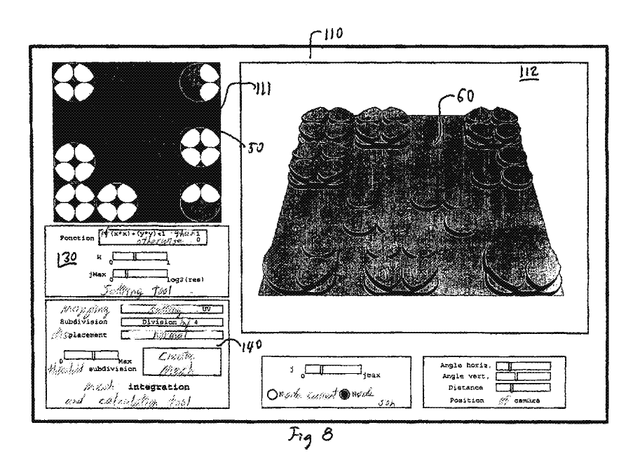

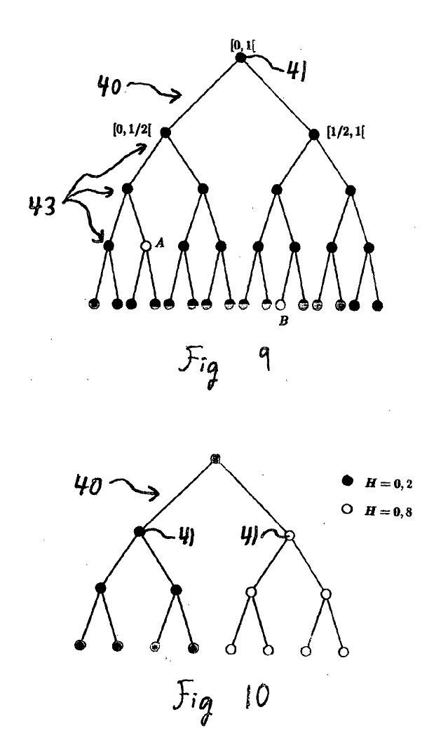

FIG. 4 presents the mapping step between the points of the procedural map and the corresponding ones of the mesh, with the map and the mesh presented on FIG. 3. The type of correspondence, the number of subdivision to be applied to the initial mesh as well as the type of displacement can be indicated by the user with the various mesh integration and calculation tools 140 provided on the working interface 110. The dotted lines arrows show how the points of the map are paired with those of the mesh. Once the mapping carried out, the “mesh creation” command 145 enables to carry out various calculations necessary to carry out displacements of the points designated by the map.

Mesh visualization window 112 of FIG. 5 shows the mesh 60 once displacements have been carried out. This same figure also shows the selection tool 123 or target used in order to select a portion of the mesh on which the user wishes to carry out local modifications. He selects the working level and to which nodes the modifications will apply, with commands 121 and 126.

FIG. 6 illustrates the following step, consisting in carrying out the desired modifications on the selected portion of mesh. In this example the user moves the selected mesh portion to position it at another place, as indicated by the arrow in dotted line. The working interface enables the user to work from the display window, which is particularly useful for a proper visualization of the effect of the modifications in progress on the mesh. FIG. 6 clearly shows that at this step, the new mesh is not calculated yet. The window presents (inside the target 23) an image of the section of the selected procedural map. It is to be observed on this same figure, the procedural map visualization window 111 which clearly shows the modification made to the map.

In this example, the modifications are carried out and commanded from the mesh visualization window 112. According to a variant of realization, the modifications may be commanded and carried out from the map visualization window 111.

When the user is satisfied with the modifications made to the map, he may launch the calculation for the creation of the mesh comprising these modifications. FIG. 7 presents this step, in which the modified mesh is processed, for example by activation of the “mesh creation” command 145. One sees on the figure vertical displacements appearing in the mesh portion which was moved.

Lastly, FIG. 8 illustrates the end result obtained once the entire modifications have been carried out.

The example of realization of integrator 100 was described and presented with an interface 110 in which we find at the same time the procedural maps working tools and those relating to the mesh. According to various variants, the tool is divided into various subsets. For example, it includes a tool and an interface as those of FIG. 24, used in parallel with an interface for mesh management deprived of map window display and of map parameter setting tools.

1. A mesh design process to generate or modify a mesh of an input assembly comprising a plurality of elementary geometrical forms describing a surface in a three-dimensional space according to an initial spatial arrangement on which the procedural map is capable to act in order to modify said spatial arrangement, the process comprising:
a. inputting data constituting the mesh to be processed in a mesh modification tool;
b. inputting the parameters of at least one modifiable procedural map intended to produce a spatial cursor in a tool for generation or modification of procedural maps;
c. generating the procedural map using said tool for generation or modification of modifiable procedural map;
d. carrying out a mapping between the various points of the procedural map and the corresponding points of the mesh;
e. re-arranging at least part of the points of the input assembly according to the data provided by the procedural maps in order to generate a spatial arrangement modified for at least part of the elementary geometrical forms.

2. A design process according to claim 1, in which the re-arrangement of the points is commanded by at least one modifiable procedural map comprising indications relative to a direction and a distance for the points to be moved.

3. A design process according to claim 1, in which said map is a procedural map, having a tree structure, comprising a plurality of levels, each one with at least a node, said map being intended to produce a spatial cursor, corresponding to at least one parameter.

4. A design process according to claim 1, further comprising one subdivision step consisting in subdividing at least a portion of the elementary geometrical forms.

5. A design process according to claim 4, in which the subdivision step consists to:
a. check if the criterion defined to stop the subdivision is reached;
b. if the criterion is not satisfied, carry out at least one subdivision and come back to step (a);
c. if the criterion is met, stop the subdivision.

6. A design process according to claim 1, further comprising a step of displaying the mesh.

7. A design process according to claim 1, further comprising a step of displaying at least one of the implemented procedural maps.

8. A design process according to claim 1, in which one modifies at least one procedural map.

9. A design process according to claim 1, in which at least one procedural map is time dependant.

10. A design process according to claim 1, in which the mesh is generated by a mesh generator.

11. A mesh designing tool for the implementation of the process according to claim 1, intended to generate or modify a mesh from an input assembly comprising a plurality of elementary geometrical forms describing a surface in a three-dimensional space according to an initial spatial arrangement on which the procedural map is capable to act in order to modify said arrangement, said tool including:
a mesh input unit, to receive the data corresponding to a mesh to modify;
a procedural map generation or modification tool allowing the generation of procedural maps having a tree structure, comprising a plurality of levels, each one with at least a node to which corresponds at least one parameter, intended to provide a spatial cursor, including:
a map parameter input unit, to input preset parameters of procedural maps taking into account the data of at least one input assembly on which the spatial cursor will act in order to modify the initial spatial arrangement;
a processing unit intended to process said parameters, in order to generate said spatial cursor map, so that the map has a tree structure;
operating instructions, to ensure the operation of the tool and in particular of the processing unit;
an output, allowing to transmit the resulting maps;
an integrator, capable on the one hand to put in correspondence the various points of the spatial cursor with the corresponding mesh points, and on the other hand to re-arrange at least part of the points of the input assembly according to the data provided by the procedural maps in order to generate a modified spatial arrangement for at least part of the elementary geometrical forms.

12. A mesh designing tool according to claim 11, comprising, during its implementation, a mesh visualization window, capable to display the mesh to be modified.

13. A mesh designing tool according to claim 12, further comprising a node selection tool allowing the selection of at least one node of a map level.

14. A mesh designing tool according to claim 11, further comprising:
a tool for the selection and modification of maps parameters, for on the one hand selecting a parameter to be modified, and on the other hand to allow the input of the new value of the parameter;
a processing unit intended to process said parameters in order to generate said modified map;
operating instructions, to ensure the operation of the tool and in particular of the processing unit;
an output, allowing to provide the modified map.

15. A mesh designing tool according to claim 13, in which the node selection tool comprises a unit for depth selection, allowing to select the extent of the modification to be made on the tree.

16. A mesh designing tool according to claim 13, in which the node selection tool comprises a mobile frame for localization of node-object.

17. A mesh designing tool according to claim 16, in which said frame is commanded by a cursor directly from the working interface.

18. A mesh designing tool according to claim 11, further comprising a module for mesh generation.
